(19) United States
(12) Patent Application Publication
(10) Pub. No.: US 2017/0329431 A1
(43) Pub. Date: Nov. 16, 2017

(54) PROXIMITY DETECTION FOR ABSORPTIVE AND REFLECTIVE OBJECT USING ULTRASOUND SIGNALS

(71) Applicant: MediaTek Inc., Hsin-Chu (TW)

(72) Inventors: Che-Kuang LIN, New Taipei City (TW); Yiou-Wen CHENG, Hsinchu City (TW)

(21) Appl. No.: 15/150,553

(22) Filed: May 10, 2016

(51) Int. Cl. G06F 3/043; B06B 3/02; G06F 3/041

(52) U.S. Cl. CPC G06F 3/043; G06F 3/0416; B06B 3/02; B06B 2201/70; G06F 2203/04101

(57) ABSTRACT

A proximity detection method for detecting absorptive and reflective proximal objects using ultrasound signals and an associated electronic device are provided. The electronic device includes an audio codec, and an acoustics module having a microphone and a speaker. The method includes the steps of: utilizing the speaker to emit an ultrasound signal encoded by the audio codec; utilizing the microphone to sense to generate an incoming ultrasound signal associated with the emitted ultrasound signal; decoding the incoming ultrasound signal into ultrasound waves; and analyzing the ultrasound waves to detect the proximity of a proximal object.

### BACKGROUND OF THE INVENTION

### Field of the Invention

The invention relates to touch detection, and, in particular, to a proximity detection method for detecting absorptive and reflective proximal objects using ultrasound signals and an associated electronic device.

### Description of the Related Art

Advances in technology have resulted in smaller and more powerful personal computing devices. Generally, a conventional mobile device detects the proximity of a nearby object using an infrared (IR) sensor. However, there are some limits of the IR sensor, such as there being an extra hole on the surface and being sensitive to IR-absorptive materials. This results in an inability to detect the proximity of an object, in some circumstances. Instead, ultrasound signals can be used to detect the proximity of an object. However, conventional ultrasound-based analysis still fails to detect sound-absorptive objects.

Accordingly, there is demand for a proximity detection method and an associated electronic device to solve the aforementioned problem.

### BRIEF SUMMARY OF THE INVENTION

A detailed description is given in the following embodiments with reference to the accompanying drawings.

In an exemplary embodiment, an electronic device is provided. The electronic includes: a processor; an audio codec; and an acoustics module. The acoustics module includes a speaker, for emitting an ultrasound signal encoded by the audio codec, and a microphone, for sensing to generate an incoming ultrasound signal associated with the emitted ultrasound signal. The audio codec decodes the incoming ultrasound signal into ultrasound waves, and the processor analyzes the ultrasound waves to detect proximity of a proximal object.

In another exemplary embodiment, a proximity detection method for detecting absorptive and reflective proximal objects is provided. The electronic device includes an audio codec, and an acoustics module having a microphone and a speaker. The method includes the steps of: utilizing the speaker to emit an ultrasound signal encoded by the audio codec; utilizing the microphone to sense to generate an incoming ultrasound signal associated with the emitted ultrasound signal; decoding the incoming ultrasound signal into ultrasound waves; and analyzing the ultrasound waves to detect proximity of a proximal object.

### BRIEF DESCRIPTION OF THE DRAWINGS

The invention can be more fully understood by reading the subsequent detailed description and examples with references made to the accompanying drawings, wherein:

FIG. 1 is a block diagram of an electronic device in accordance with an embodiment of the invention;

FIG. 2A is a front view of the electronic device 100 in accordance with an embodiment of the invention;

FIG. 2B is a top perspective plan view of the acoustics module in accordance with an embodiment of the invention;

FIG. 2C is a side perspective plan view of the acoustics module in accordance with an embodiment of the invention;

FIG. 3A is a diagram illustrating the flow of tracking the absorptive/reflective response of a proximal object in accordance with an embodiment of the invention;

FIG. 3B is a diagram illustrating the flow of tracking the absorptive/reflective response of a proximal object in accordance with another embodiment of the invention;

FIG. 4A is a diagram illustrating a multi-band analysis of an ultrasound signal in accordance with an embodiment of the invention;

FIG. 4B is a diagram illustrating reference floor signals in different time points in accordance with an embodiment of the invention;

FIG. 5 is a flow chart of a method for tracking a sound absorptive/reflective proximal object in accordance with an embodiment of the invention;

FIG. 6 is a flow chart of the steps in making a decision based on the difference between the reflected ultrasound signal and original ultrasound signal in accordance with an embodiment of the invention;

FIG. 7A-7C are diagrams illustrating encoding acoustic patterns into an ultrasound signal in accordance with an embodiment of the invention;

FIGS. 7D-7E are diagrams of an ultrasound signal encoded with different frequencies in accordance with another embodiment of the invention; and

FIG. 7F is a diagram of an ultrasound signal encoded with varying amplitudes in accordance with yet another embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

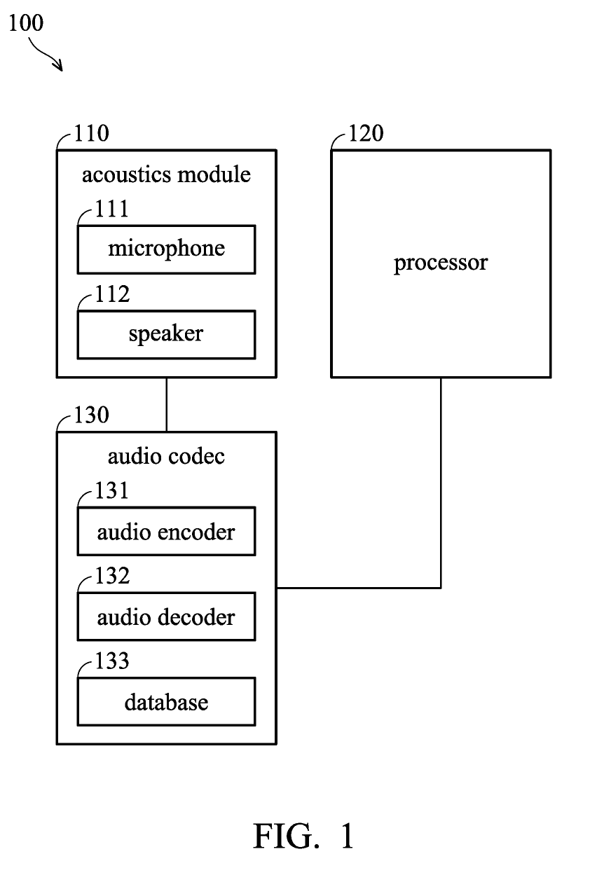

FIG. 1 is a block diagram of an electronic device in accordance with an embodiment of the invention. In an embodiment, the electronic device 100 may be a portable device such as a cellular phone, a smartphone, a tablet PC, etc. In some embodiments, the electronic device may be a wearable device such as a smart watch, smart wristband, a pair of smart glasses, etc., but the invention is not limited thereto. The electronic device 100 comprises an acoustics module 110, a processor 120, and an audio codec 130. The acoustics module 110 is coupled to the processor 120 and the audio codec 130. The acoustics module 110 comprises a microphone 111 and a speaker 112, where the microphone 111 is configured to sense acoustic sounds or ultrasound sounds to generate corresponding acoustic signals or ultrasound signals, and the speaker 112 is configured to emit acoustic signals or ultrasound signals programmed by the processor 120. The processor 120 may be a central processing unit (CPU), a digital signal processor (DSP), or any other equivalent circuits. The audio codec 130 comprises an audio encoder 131, an audio decoder 132, and a database 133. The audio encoder 131 is configured to encode specific acoustic/ultrasound waves or patterns into acoustic signals that are emitted by the speaker 112 of the acoustics module 110. The audio decoder 132 is configured to decode acoustic signals or ultrasound signals generated by the microphone 111 into acoustic waves for analysis. The database 133 is configured to record various patterns of the test acoustic or ultrasound signals that can be accessed by both the audio encoder 131 and the audio decoder 132.

In an embodiment, the electronic device 100 is capable of detecting a proximal object using the acoustics module 110. Specifically, the electronic device 100 may detect the proximal object using acoustic signals or ultrasound signals. For example, the processor 120 may generate a specific multi-tone noise, band-pass noise or any other type of acoustic noise, and the audio encoder 111 may encode the noise generated by the processor 120 to an output ultrasound signal. In cases where the proximal object is not at a position attached to the surface of the acoustics module 110, when the ultrasound signal has reached the proximal object (e.g. made of a sound-reflective material), the ultrasound signal will be reflected by the proximal object, and thus the microphone 111 may receive the reflected ultrasound signal. The audio decoder 132 may decode the reflected ultrasound signal into sound waves, so that the processor 120 may perform a long-term signal analysis and a short-term signal analysis on the decoded sound waves. For example, the environment signal floor may stay the same or may not change a lot, and thus the analysis for the environment signal floor can be regarded as a long-term signal analysis. When it is detected that there is at least one object in the environment, the long-term signal analysis with a longer updating period (i.e. at a lower frequency) is used, so that the environment signal floor will not change soon or will not be affected by the response of the detected object too much. In addition, the response of the reflected ultrasound signal may change within a short period, and thus the analysis for the response of the reflected ultrasound signal is regarded as a short-term signal analysis. When it is detected that there is no object in the environment, the short-term analysis with a shorter updating period is used. Accordingly, the detection for the proximal object may be maintained at a higher frequency in some embodiments.

Accordingly, the processor 120 may determine the proximity of the proximal object based on the analysis results. In an embodiment, when the proximal object is made of sound-absorptive material (e.g. sound absorption cotton), there might be no or not much reflected ultrasound signal from the proximal object. Accordingly, a proximity detection method for sound absorptive materials is provided in the invention, and the details will be described later.

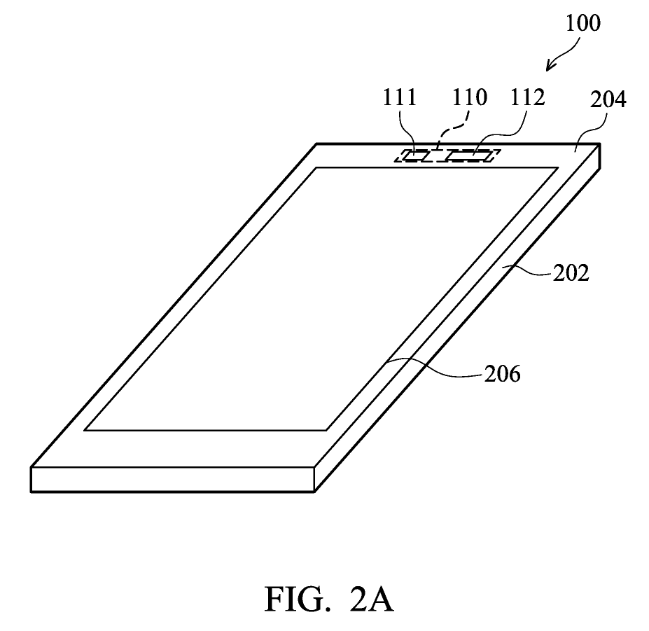

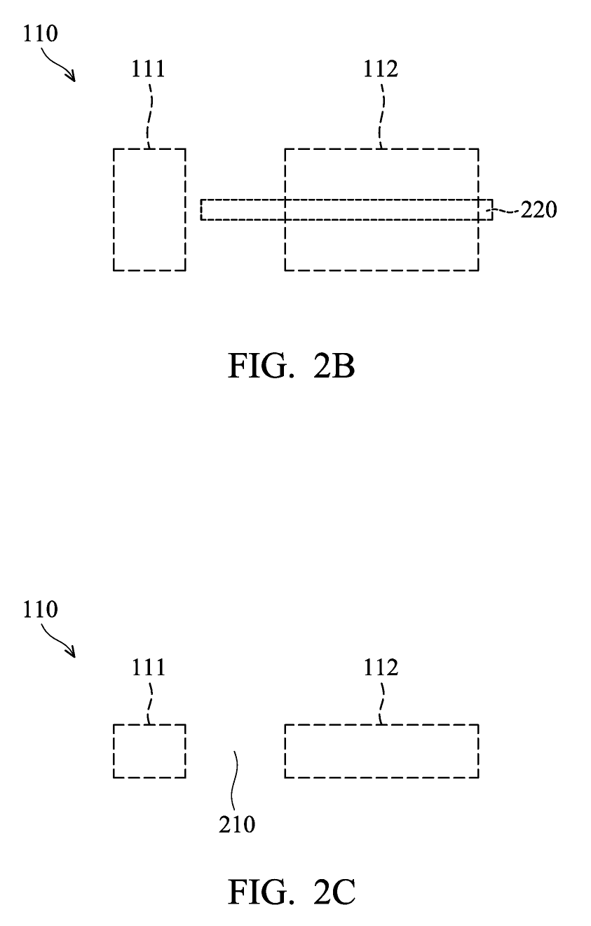

FIG. 2A is a front view of the electronic device 100 in accordance with an embodiment of the invention. FIG. 2B is a top perspective plan view of the acoustics module in accordance with an embodiment of the invention. FIG. 2C is a side perspective plan view of the acoustics module in accordance with an embodiment of the invention. Referring to FIG. 2A, the acoustics module 110 is disposed on a specific position of the upper surface 204 of the housing 202 of the electronic device 100, where the display screen 206 of the electronic device 100 may be also disposed on the upper surface 204. It should be noted that the position of the acoustics module 110 shown in FIG. 2A is only for purposes of description. One having ordinary skill in the art will appreciate that the acoustic module 110 may form any other structure and can be disposed on any other designated position on the housing 202. For purposes of description, the usage of the microphone 111 and speaker 112 is shown as a form of an acoustics module. One having ordinary skill in the art will appreciate that the microphone and speaker disposed on an existing mobile device can be used as the acoustics module 110 in the application, and there is no specific structure of the acoustics module 110. As a result, no additional hole is required for the acoustics module 110 of such existing mobile device. In some embodiments, another application or software other than the proximity detection application may also utilize the microphone 111 and speaker 112. Referring to FIG. 2B, the microphone 111 and speaker 112 in the acoustics module 110 are placed very close to each other. However, there is a void space 210 between the microphone 111 and speaker 112 to avoid mutual vibration, as shown in FIG. 2C. In addition, there are one or more holes 220 (shown in FIG. 2B) on the surface of the acoustics module 110, so that the acoustic signals or ultrasound signals emitted from the speaker 112 are not blocked. For example, the one or more holes on the surface of the acoustics module 110 may be an empty line or a plurality of empty holes, but the invention is not limited thereto.

In cases where the proximal object is at a position attached to the surface of the acoustics module 110, the path for emitting the acoustic signals or ultrasound signals to the exterior space of the electronic device 100 may be blocked. However, since there is a void space 210 between the microphone 111 and speaker 112, the acoustic signals or ultrasound signals emitted from the speaker 112 can still be sensed by the microphone 111 via a direct path through the void space.

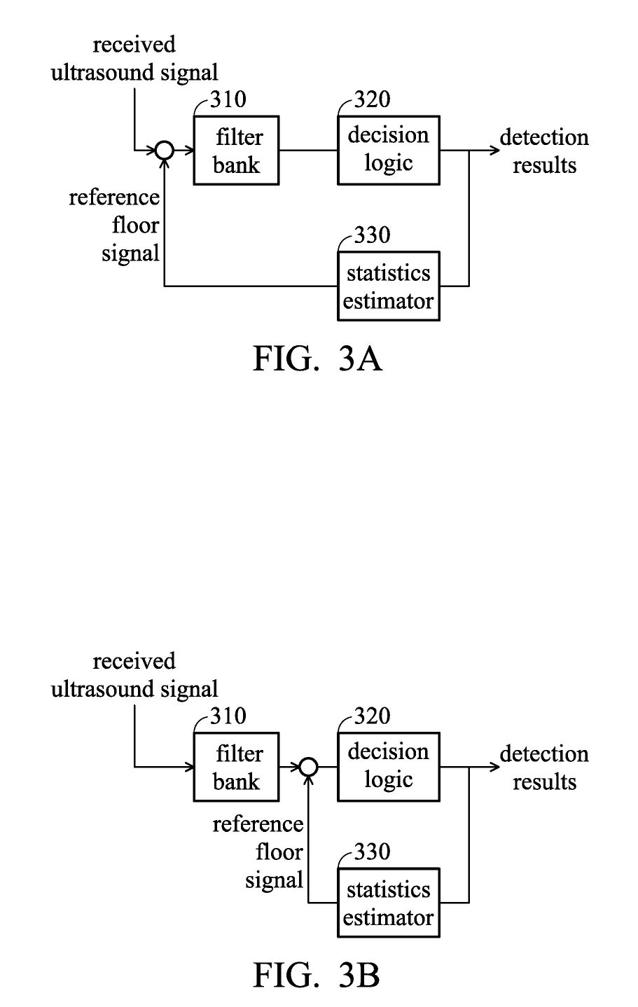

FIG. 3A is a diagram illustrating the flow of tracking the absorptive/reflective response of a proximal object in accordance with an embodiment of the invention. For example, the received ultrasound signal is sent to the filter bank 310 for a long-term analysis and a short-term analysis. The reference floor signal indicates the response in a given environment or background such as an office, a meeting room, outdoors, etc. It should be noted that the received ultrasound signal represents the neighboring response which includes the response represented by the reference floor signal before filtering. The filtered ultrasound signal is sent to the decision logic 320. According to the filtered ultrasound signal, the decision logic 320 may determine whether there is a proximal object close to the electronic device, and it also may determine whether the proximal object is made of a sound absorptive material or a sound reflective material. The statistics estimator 330 may update the reference floor signal based on the decision made by the decision logic 320. It should be noted that changes of the statistics of the environment have been considered in the updated reference floor signal. Notably, the decision logic 320 can be implemented by the processor 120 or a specific circuit.

FIG. 3B is a diagram illustrating the flow of tracking the absorptive/reflective response of a proximal object in accordance with another embodiment of the invention. The flow shown in FIG. 3B is different from that in FIG. 3A. The received ultrasound signal is directly sent to the filter bank 310. According to the ultrasound signal filtered by the filter bank 310 and the reference floor signal from the statistics estimator 330, the decision logic 320 may determine whether there is a proximal object close to the electronic device, and it also may determine whether the proximal object is made of a sound absorptive material or a sound reflective material. The statistics estimator 330 may update the reference floor signal based on the decision made by the decision logic 320. It should be noted that changes of the statistics of the environment have been considered in the updated reference floor signal. Notably, the decision logic 320 can be implemented by the processor 120 or a specific circuit.

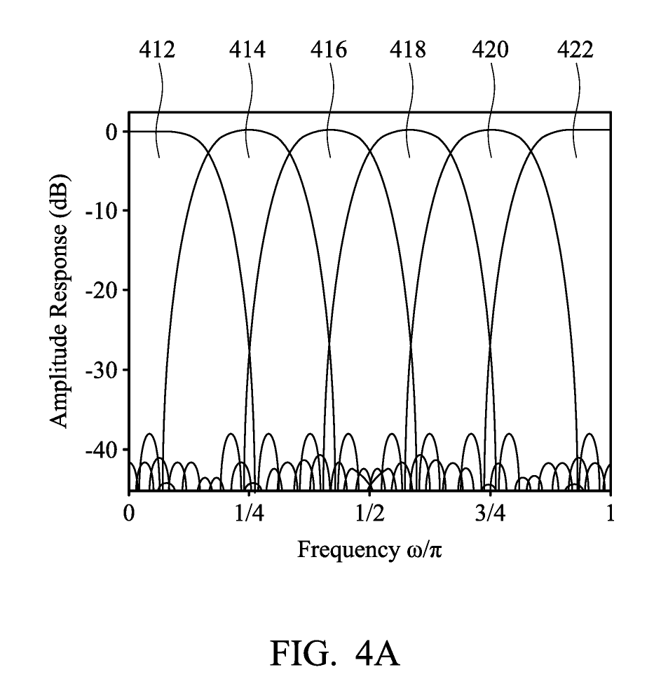

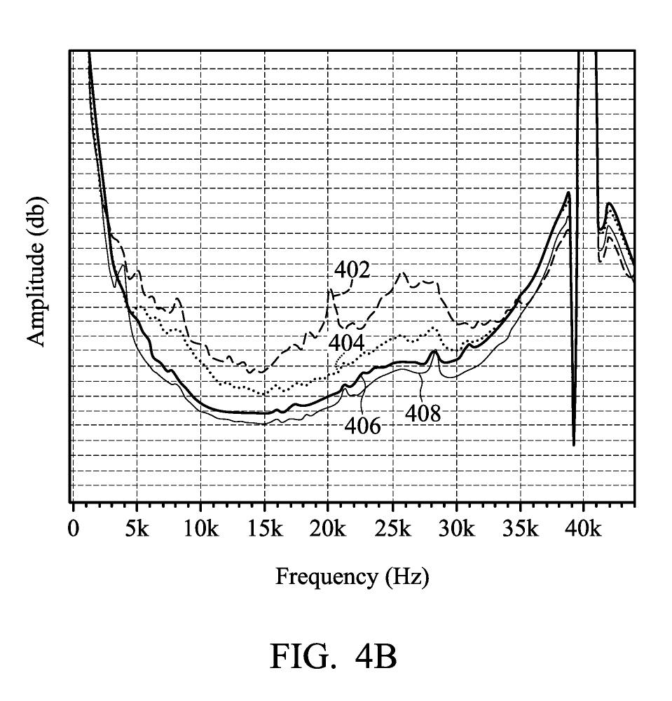

FIG. 4A is a diagram illustrating a multi-band analysis of an ultrasound signal in accordance with an embodiment of the invention. FIG. 4B is a diagram illustrating reference floor signals in different time points in accordance with an embodiment of the invention. It should be noted that most materials have a significant sound reflection pattern. For example, the amplitude and phase may be changed on the reflected ultrasound signal compared to the original ultrasound signal when using different materials or being in different environments. When the proximal object is made of a specific sound-reflective material, the processor 120 may perform multi-band analysis on the waves of the reflected ultrasound signal to detect the proximity of the proximal object. For example, the processor 120 may analyze the response of the waves of the ultrasound signal at different frequency bands 412, 414, 416, 418, 420, and 422 in a specific environment, as shown in FIG. 4A. Similarly, the responses at different frequency bands can be also analyzed in other environments (for example, to generate an analysis as shown in FIG. 4A), and thus a reference floor signal in a given environment can be estimated or obtained, such as one of the curves 402˜408 shown in FIG. 4B. Referring to FIG. 4B, the x-axis denotes the frequency of the reference floor signal, and the y-axis denotes the amplitude of the reference floor signal. For example, given that the curve 402 is the initially determined reference floor signal, and the curve 402 denotes a reference for the response of a specific sound absorptive material with a given ultrasound signal. During the procedure of determination of the proximal object, it may be determined that the proximal object may or may not exist in the environment associated with the electronic device 100. The decision logic of the processor 120 may determine whether the proximal exists, and update the reference floor signal according to the determination, as shown in FIG. 3A and FIG. 3B. Accordingly, the updated reference floor signal may be one of the curves 404˜408. Subsequently, the processor 120 further keeps updating the reference floor signal according to the determination from the decision logic, and thus different reference floor signals in different time points can be obtained, such as curves 402˜408 shown in FIG. 4B.

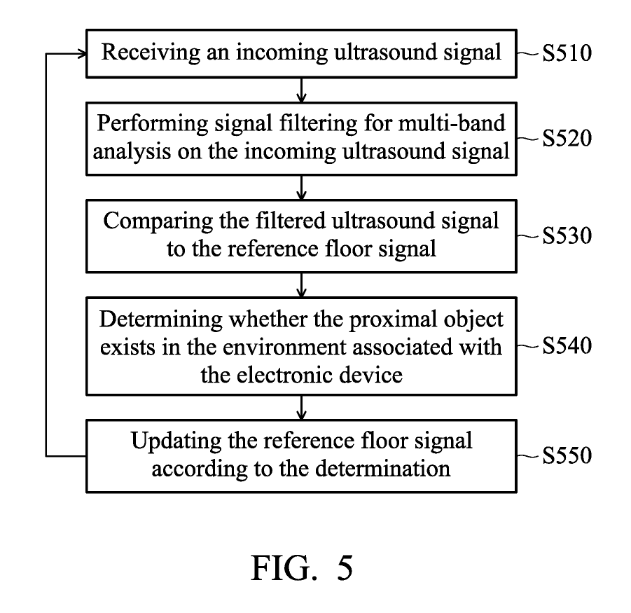

FIG. 5 is a flow chart of a method for tracking a sound absorptive/responsive proximal object in accordance with an embodiment of the invention. In step S510, an incoming ultrasound signal is received. In step S520, signal filtering for multi-band analysis is performed on the incoming ultrasound signal. In step S530, the filtered ultrasound signal is compared to the reference floor signal.

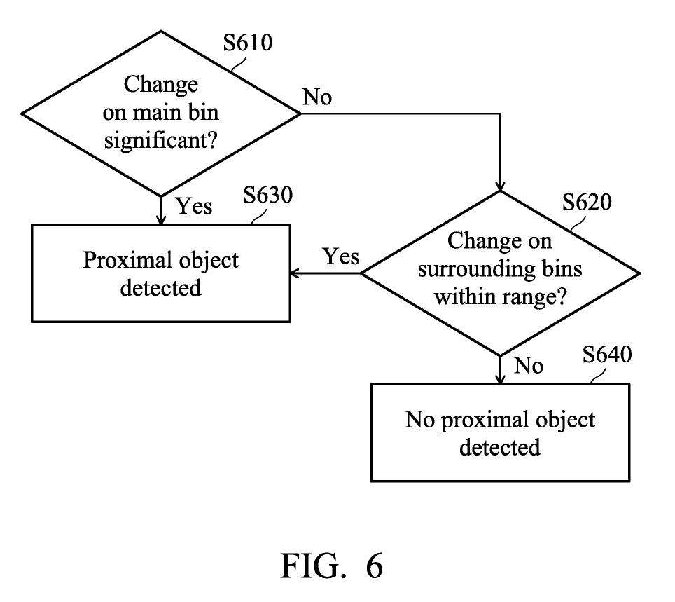

In step S540, it is determined whether the proximal object exists in the environment associated with the electronic device 100. It should be noted that the steps 530 and 540 are performed in the decision logic 320 shown in FIG. 3A or FIG. 3B, and the details for detecting the proximal object are further described in the embodiment of FIG. 6. In step S550, the reference floor signal is updated according to the determination, and the flow goes back to step S510. It should be noted that the step S550 is performed by the statistics estimator 330 shown in FIG. 3A or FIG. 3B. For example, the statistics estimator 330 updates the statistics of the environment according to the determination (such as using a lower frequency when it is determined that the proximal object exists, and using a higher frequency when it is determined that the proximal object does not exist), and then update the reference floor signal based on the updated statistics of the environment. In some other embodiments, the statistics estimator 330 updates the reference floor signal, which represents the statistics of the environment, according to the determination (such as using a lower frequency when it is determined that the proximal object exists, and using a higher frequency when it is determined that the proximal object does not exist). Thus, changes of the statistics of the environment have been considered in the updated reference floor signal. In addition, for ultrasound-absorptive materials, an environment background floor signal that slowly changes (i.e. long-term analysis using a lower frequency) can be used to detect signal absorption.

FIG. 6 is a flow chart of the step of making a decision based on the difference between the reflected ultrasound signal and original ultrasound signal in accordance with an embodiment of the invention. It should be noted that the reflection pattern changes slightly when the proximal object is made of a sound-absorptive material. In an embodiment, a test ultrasound signal having a specific frequency (e.g. 40K Hz) with a large amplitude is emitted from the speaker 112, wherein the specific frequency is regarded as a “main bin”, and other frequencies are regarded as “surrounding bins”. In step S610, the processor 120 may determine whether there is significant change on the “main bin” of the reflection pattern of the reflected test ultrasound signal. If there is significant change on the reflection pattern (i.e. response), the processor 120 may determine that there is a proximal object close to the acoustics module 110 (i.e. step S630). If there is no significant change on the reflection pattern of the reflected test ultrasound signal, the processor 120 may further determine whether the change (i.e. it may be positive or negative) of the amplitude of the reflected pattern of the surrounding bins is within a predetermined range (e.g. 0.5 db) (step S620). If the change of the amplitude of the reflected pattern of the surrounding bins is within a predetermined range, the processor 120 may further determine that there is no proximal object detected (step S640). If the change of the amplitude of the reflected pattern of the surrounding bins is within a predetermined range, the processor 120 may determine that there is a proximal object close to the acoustics module 110 or in the environment associated with the electronic device 100 (step S630).

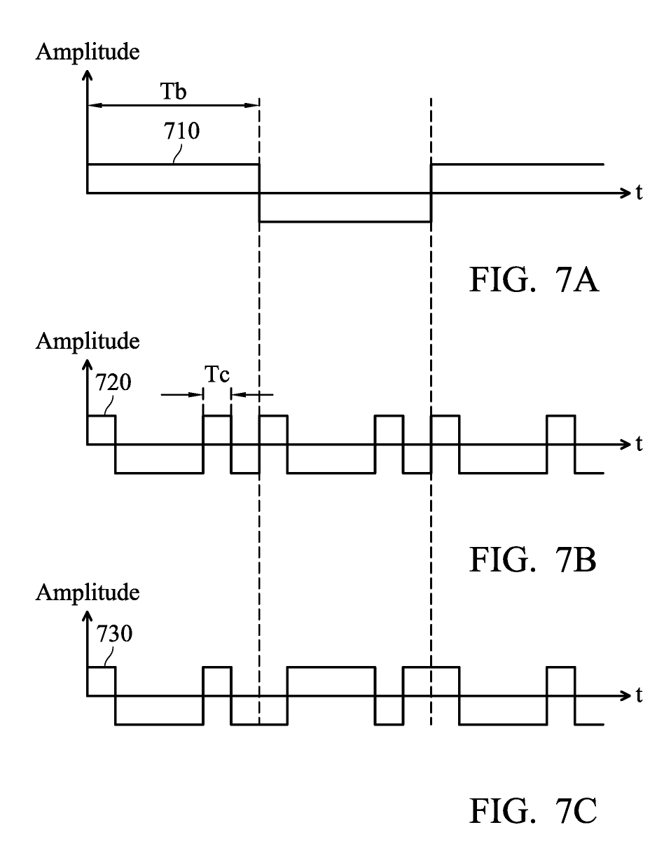

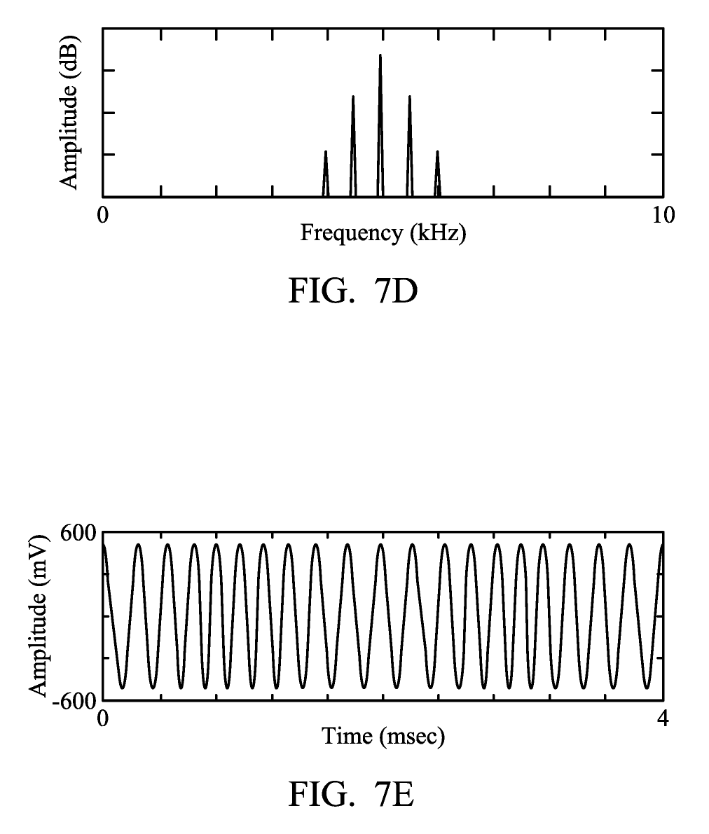

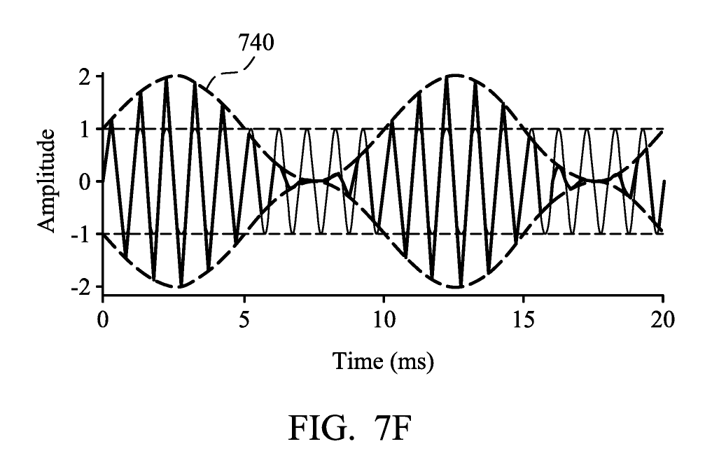

FIG. 7A-7C are diagrams illustrating encoding acoustic patterns into an ultrasound signal in accordance with an embodiment of the invention. It should be noted that the audio codec 130 may further comprise a database 133 of test ultrasound signals, and the audio encoder 131 and the audio decoder 132 may access the database 133. For example, a given electronic device 100 should be a unique test ultrasound signal in order to prevent interference from other electronic devices. In an embodiment, an exemplary ultrasound signal 710 having a period of Tb is given, as shown in FIG. 7A. Then, one ultrasound code signal 720 is selected from the database 133, as shown in FIG. 7B. The audio encoder 131 may perform convolution on both the ultrasound signal 710 and the ultrasound code signal 720 to obtain the coded ultrasound signal 730 that are emitted by the speaker 112, as shown in FIG. 7C. The ultrasound code signal 720 is for illustrative purposes, and one having ordinary skill in the art will appreciate that numerous unique code signals can be pre-designed and stored in the database 133. Specifically, multi-tone patterns are transmitted by the speaker 112 based on the user-specific codes, and the tone patterns are arranged round robin based on the user-specific codes. Accordingly, FIGS. 7A-7C illustrate a time domain approach for encoding the test ultrasound signal.

FIGS. 7D-7E are diagrams of an ultrasound signal encoded with different frequencies in accordance with another embodiment of the invention. In an alternative embodiment, the specific frequency of the test ultrasound signal, as shown in FIG. 7D, can vary from the pre-designed pattern shown in FIG. 7E. For example, the specific frequency is shifted based on a pseudo random number sequence, and thus each electronic device may have its own unique specific frequency, thereby preventing interference from other electronic devices. Accordingly, FIGS. 7D-7E illustrate a frequency domain approach for encoding the test ultrasound signal.

FIG. 7F is a diagram of an ultrasound signal encoded with varying amplitudes in accordance with yet another embodiment of the invention. In an alternative embodiment, the amplitude of the test ultrasound signal is varied with pre-designed patterns. For example, the amplitude of the test ultrasound signal may change over time. That is, the shape of the envelope of the transmitted ultrasound signal changes over time, where the shape 740 of the envelope can be selected from among a number of previously designed envelope shapes, so that each electronic device may have a unique envelope for its test ultrasound signal. Accordingly, FIG. 7F illustrates a power domain approach for encoding the test ultrasound signal.

It should also be noted that the techniques in the time domain, frequency domain, and power domain as described in embodiments of FIGS. 7A-7F can be combined or integrated, thereby improving the confidence of preventing interference from other electronic devices.

In some embodiments, the acoustics module 110 is installed on the same surface of the display (not shown) or one of the side surfaces of the electronic device 100 for detecting the proximity of absorptive or reflective proximal objects. In some other embodiments, the acoustics module 110 can be installed on the opposite side of the display of the electronic device 100 for detecting the proximity of absorptive or reflective proximal objects. Thus, when the user is walking and viewing the display, the proximity detection method may detect surrounding dangers that are approaching the user. For example, when the electronic device 100 is a wearable device such as a pair of shoes, the user can be warned before approaching a cliff, desk legs, empty ground, etc. When the electronic device 100 is a wearable device such as a pair of smart glasses, the user can be warned before approaching a pane of glass.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electronic device, comprising:
a processor;
an audio codec; and
an acoustics module, comprising:
a speaker, for emitting an ultrasound signal encoded by the audio codec; and
a microphone, for sensing to generate an incoming ultrasound signal associated with the emitted ultrasound signal;
wherein the audio codec decodes the incoming ultrasound signal into ultrasound waves, and the processor analyzes the ultrasound waves to detect proximity of a proximal object.

2. The electronic device as claimed in claim 1, wherein the processor performs a multi-band analysis on the ultrasound waves to obtain a response signal, and compares the response signal with a reference floor signal.

3. The electronic device as claimed in claim 2, wherein the audio codec encodes the ultrasound signal using a specific frequency.

4. The electronic device as claimed in claim 3, wherein when the amplitude of the ultrasound waves at the specific frequency is larger than a first threshold, the processor determines that the proximal object is made of a sound reflective material and is close to the electronic device.

5. The electronic device as claimed in claim 4, wherein when the difference between the response signal and the reference floor signal at surrounding frequencies of the specific frequency is larger than a second threshold, the processor determines that the proximal object is made of a sound absorptive material and is close to the electronic device.

6. The electronic device as claimed in claim 3, wherein the audio codec shifts the specific frequency using a pseudo random number sequence.

7. The electronic device as claimed in claim 1, wherein the processor comprises decision logic that is configured to determine whether the proximal object is in an environment associated with the electronic device, and update a reference floor signal according to the determination.

8. The electronic device as claimed in claim 7, wherein when the determination indicates that the proximal object exists in the environment associated with the electronic device, a first frequency is used to update the reference floor signal, and when the determination indicates that no proximal object exists in the environment associated with the electronic device, a second frequency is used to update the reference floor signal, wherein the second frequency is higher than the first frequency.

9. The electronic device as claimed in claim 1, wherein the audio codec performs convolution between a specific code signal having a specific multi-tone pattern and an original ultrasound wave to generate the ultrasound signal.

10. The electronic device as claimed in claim 1, wherein the audio codec encodes an original ultrasound wave with a specific envelope shape to generate the ultrasound signal.

11. The electronic device as claimed in claim 1, wherein the acoustics module is installed at the same side of a display of the electronic device.

12. The electronic device as claimed in claim 1, wherein the acoustics module is installed at an opposite side of a display of the electronic device.

13. A proximity detection method for detecting absorptive and reflective proximal objects of an electronic device, wherein the electronic device comprises an audio codec, and an acoustics module having a microphone and a speaker, the method comprising:
utilizing the speaker to emit an ultrasound signal encoded by the audio codec;
utilizing the microphone to sense to generate an incoming ultrasound signal associated with the emitted ultrasound signal;
decoding the incoming ultrasound signal into ultrasound waves; and
analyzing the ultrasound waves to detect proximity of a proximal object.

14. The method as claimed in claim 13, further comprising:
performing a multi-band analysis on the ultrasound waves to obtain a response signal; and
comparing the response signal with a reference floor signal.

15. The method as claimed in claim 14, further comprising:
utilizing the audio codec to encode the ultrasound signal using a specific frequency.

16. The method as claimed in claim 15, further comprising:
when the amplitude of the ultrasound waves at the specific frequency is larger than a first threshold, determining that the proximal object is made of a sound reflective material and is close to the electronic device.

17. The method as claimed in claim 16, further comprising:
when the difference between the response signal and the reference floor signal at surrounding frequencies of the specific frequency is larger than a second threshold, determining that the proximal object is made of a sound absorptive material and is close to the electronic device.

18. The method as claimed in claim 15, wherein the audio codec shifts the specific frequency using a pseudo random number sequence.

19. The method as claimed in claim 13, further comprising:
determining whether the proximal exists in an environment associated with the electronic device; and
updating the reference floor signal according to the determination.

20. The method as claimed in claim 18, further comprising:
when the determination indicates that the proximal object exists in the environment associated with the electronic device, using a first frequency to update the reference floor signal; and
when the determination indicates that no proximal object exists in the environment associated with the electronic device, using a second frequency to update the reference floor signal, wherein the second frequency is higher than the first frequency.

21. The method as claimed in claim 13, further comprising:
utilizing the audio codec to perform convolution between a specific code signal having a specific multi-tone pattern and an original ultrasound wave to generate the ultrasound signal.

22. The method as claimed in claim 13, further comprising:
utilizing the audio codec to encode an original ultrasound wave with a specific envelope shape to generate the ultrasound signal.

23. The method as claimed in claim 13, wherein the acoustics module is installed at the same side of a display of the electronic device.

24. The method as claimed in claim 13, wherein the acoustics module is installed at an opposite side of a display of the electronic device.
